(19) United States
(12) Patent Application Publication
(10) Pub. No.: US 2023/0331320 A1
(43) Pub. Date: Oct. 19, 2023

(54) PIVOTING ASSEMBLY AND TRACK SYSTEM COMPRISING SAME

(71) Applicant: SOUCY INTERNATIONAL INC., Drummondville (CA)

(72) Inventor: Jeremie AUBIN-MARCHAND, St-Hugues (CA)

(21) Appl. No.: 18/136,650

(22) Filed: Apr. 19, 2023

Related U.S. Application Data
(60) Provisional application No. 63/332,464, filed on Apr. 19, 2022.

(51) Int. Cl. B62D 55/084

(52) U.S. Cl. CPC B62D 55/084

(57) ABSTRACT

A pivoting assembly for connecting at least one-wheel assembly to a frame of a track system is disclosed. The pivoting assembly includes first, intermediate and second clamping members and first and second resilient members. The first resilient member is removably engageable with the first and intermediate clamping members. The second resilient member is removably engageable with the intermediate and second clamping members. The first and second clamping members are removably connectable to one another. The intermediate clamping member, which is pivotable about a pivot axis, has a first position. In response to the intermediate clamping member pivoting about the pivot axis, at least one of the first and second resilient members biases the intermediate clamping member towards the first position.

### CROSS-REFERENCE TO RELATED APPLICATION

The present application claims priority to U.S. Provisional Patent Application No. 63/332,464, filed Apr. 19, 2022 entitled “Pivoting Assembly And Track System Comprising Same”, which is incorporated by reference herein in its entirety.

### TECHNICAL FIELD

The present application generally relates to pivoting assemblies and track systems including pivoting assemblies.

### BACKGROUND

Certain vehicles, such as, for example, agricultural vehicles (e.g., harvesters, combines, tractors, etc.), construction vehicles (e.g., trucks, front-end loaders, etc.) and recreational vehicles (e.g., all-terrain vehicles, utility-terrain vehicles, side-by-side vehicles, etc.) are used on ground surfaces that are soft, slippery and/or uneven (e.g., soil, mud, sand, ice, snow, etc.).

Conventionally, such vehicles have had large wheels with tires on them to move the vehicle along the ground surface. Under certain conditions, such tires may have poor traction on some kinds of ground surfaces and, as these vehicles are generally heavy, the tires may compact the ground surface in an undesirable way owing to the weight of the vehicle. For example, when the vehicle is an agricultural vehicle, the tires may compact the soil in such a way as to undesirably inhibit the growth of crops. When the vehicle is a recreational vehicle, the tires may lack traction on certain terrain and in certain conditions.

In order to reduce the aforementioned drawbacks, to increase traction and to distribute the weight of the vehicle over a larger area on the ground surface, track systems were developed to be used in place of at least some of the wheels and tires on the vehicles. For example, under certain conditions, track systems enable agricultural vehicles to be used in wet field conditions as opposed to its wheeled counterpart. In other conditions, track systems enable recreational vehicles to be used in low traction terrains such as snowy roads.

Conventional track systems do, however, present some inconveniences. When conventional track systems travel over laterally uneven surfaces, wheels can come into contact with drive lugs, which can result in premature wear of the drive lugs of the track, and/or sometimes result in detracking of the track system. Travelling over laterally uneven surface with conventional track systems can also lead to uneven load distribution across the track, which can result in premature wear of the track of the track system.

Some track systems include pivoting assemblies. These pivoting assemblies can be expensive to manufacture. These pivoting assemblies can also be expensive and/or difficult to replace.

### SUMMARY

It is an object of the present technology to ameliorate at least some of the inconveniences present in the prior art.

According to one aspect of the present technology, there is provided a pivoting assembly for connecting at least one-wheel assembly to a frame of a track system. The pivoting assembly includes a first clamping member, a first resilient member, an intermediate clamping member, a second resilient member and a second clamping member. The first resilient member is removably engageable with the first clamping member. The intermediate clamping member has a first engaging side engageable with the first resilient member, and a second engaging side having a first engaging portion and a second engaging portion. The intermediate clamping member is pivotable about a pivot axis extending generally parallel to a longitudinal center plane of the pivoting assembly. The second resilient member is removably engageable with at least one of the first and the second engaging portions of the second engaging side of the intermediate clamping member. The second clamping member is removably connectable to the first clamping member and is removably engageable with the second resilient member. The second clamping member has a receiving portion configured to at least partially receive the first resilient member, the intermediate clamping member and the second resilient member. The intermediate clamping member has a first position. In response to the intermediate clamping member pivoting about the pivot axis, at least one of the first resilient member and the second resilient member biases the intermediate clamping member towards the first position.

In some embodiments, in response to a connection between the first and second clamping members, an overall clamping force is applied, the first and intermediate clamping members distribute a first part of the overall clamping force to the first resilient member, the intermediate and second clamping members distribute a second part of the overall clamping force to the second resilient member, and the pivoting assembly is in a pre-loaded state.

In some embodiments, the first resilient member is in continuous engagement with the first and intermediate clamping members, and the second resilient member is in continuous engagement with the intermediate and second clamping members.

In some embodiments, the second resilient member is two second resilient members removably engageable with the first and second engaging portions of the intermediate clamping member, and the first resilient member, and the two second resilient members cooperate for guiding movement of the intermediate clamping member.

In some embodiments, the intermediate member further includes a third engaging portion and a fourth engaging portion, and the second resilient member is four second resilient members. The four second resilient members are removably engageable with the first, second, third and fourth engaging portions of the pivoting member.

In some embodiments, the first and second engaging portions are at an angle to one another.

In some embodiments, the angle is between about 10 and about 120 degrees.

In some embodiments, the first and second engaging portion have a V-shape.

In some embodiments, the first and second engaging portions are configured to laterally compress the second resilient member.

In some embodiments, in response to a force being applied to the intermediate clamping member, the pivot axis and the intermediate clamping member move from the first position to a second position.

In some embodiments, in response to the force being applied to the intermediate clamping member, at least one of an area of contact between the first resilient member and the first clamping member and an area of contact between the first resilient member and the first engaging side of the intermediate clamping member increases, and the first resilient member deforms.

In some embodiments, in response to a force being applied to the intermediate clamping member, at least one of an area of contact between the second resilient member and the second engaging side of the intermediate clamping member and an area of contact between the second resilient member and the second clamping member increases, and the second resilient member deforms.

In some embodiments, the first clamping member has a first inter-engageable feature, the first resilient member has a second inter-engageable feature and the first clamping member and the first resilient member are engageable by the first and second inter-engageable features.

In some embodiments, the first engaging side of the intermediate clamping member is generally flat.

In some embodiments, the first resilient member has a third inter-engageable feature, the intermediate clamping member has a fourth inter-engageable feature and the first resilient member and the intermediate clamping member are engageable by the third and fourth inter-engageable features.

In some embodiments, the first clamping member has a first abutting portion and a second abutting portion, the first and second abutting portions being configured to abut with the first resilient member for limiting longitudinal movement of the first resilient member relative to the first clamping member.

In some embodiments, at least one of the first resilient member is configured to move relative to one of the first and intermediate clamping members, and the second resilient member is configured to move relative to one of the intermediate and second clamping members.

In some embodiments, the movement of the first resilient member relative to one of the first and intermediate clamping member is a rolling movement, and the movement of the second resilient member relative to one of the intermediate and second clamping member is a rolling movement.

In some embodiments, the second clamping member is configured to limit movement of the intermediate clamping member.

In some embodiments, the second clamping member is part of the frame of the track system.

In some embodiments, the first resilient member and the second resilient member are replaceable.

In some embodiments, the first resilient member has a first mechanical property, the second resilient member has a second mechanical property, and the first and second mechanical properties are different from one another.

In some embodiments, a cross-section of at least one of the first resilient member and the second resilient member taken across a plane generally perpendicular to the longitudinal center plane of the pivoting assembly has a generally arcuate profile.

In some embodiments, the cross-section is uniform.

In some embodiments, the second resilient member is generally cylindrical, and extends generally parallel to the longitudinal center plane of the pivoting assembly.

In some embodiments, the intermediate clamping member includes at least one shaft extending generally perpendicular to the longitudinal center plane of the pivoting assembly, the at least one shaft being configured to connect to the at least one wheel assembly.

In some embodiments, the at least one wheel assembly includes a first wheel assembly and a second wheel assembly.

In some embodiments, the intermediate clamping member is configured to move in a vertical direction generally by at least about 1 millimetre.

In some embodiments, the intermediate clamping member is configured to move in a vertical direction generally by at least about 2 millimetres.

In some embodiments, the intermediate clamping member can pivot about the pivot axis by at least about 5 degrees in either direction.

In some embodiments, the intermediate clamping member can pivot about the pivot axis by at least about 10 degrees in either direction.

In some embodiments, the intermediate clamping member can pivot about the pivot axis by at least about 15 degrees in either direction.

According to another aspect of the present technology, there is provided a track system including a frame, a plurality of wheel assemblies connected to the frame and an endless track surrounding the frame and the plurality of wheel assemblies. At least one of the plurality of wheel assemblies is connected to the frame by a pivoting assembly according to the above aspect or according to the above aspect and one or more of the above embodiments.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

For purposes of the present application, terms related to spatial orientation when referring to a track system and components in relation thereto, such as “vertical”, “horizontal”, “forwardly”, “rearwardly”, “left”, “right”, “above” and “below”, are as they would be understood by a driver of a vehicle to which the track system is connected, in which the driver is sitting on the vehicle in an upright driving position, with the vehicle steered straight-ahead and being at rest on flat, level ground.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view taken from a front, top, right side of a track system including pivoting assemblies according to embodiments of the present technology;

FIG. 2A is a perspective view taken from a front, top, left side of one of the pivoting assemblies of FIG. 1;

FIG. 2B is a perspective view taken from a front, top, left side of the pivoting assembly of FIG. 1;

FIG. 3 is a top plan view of the pivoting assembly of FIG. 2A;

FIG. 4 is an exploded perspective view taken from a front, top, left side of the pivoting assembly of FIG. 2A;

FIG. 5 is an exploded perspective view taken from a front, bottom, left side of the pivoting assembly of FIG. 2A;

FIG. 6A is cross-sectional view of the pivoting assembly of FIG. 2A taken along the line 6′-6′ of FIG. 3, when the pivoting assembly is in a disconnected configuration;

FIG. 6B is cross-sectional view of the pivoting assembly of FIG. 2A taken along the line 6′-6′ of FIG. 3, when the pivoting assembly is in a connected configuration and pre-clamped state;

FIG. 6C is cross-sectional view of the pivoting assembly of FIG. 2A taken along the line 6′-6′ of FIG. 3, when the pivoting assembly is in a connected configuration and bearing an external load; and

FIG. 6D is cross-sectional view of the pivoting assembly of FIG. 2A taken along the line 6′-6′ of FIG. 3, when the pivoting assembly is in a connected pre-clamped configuration, and is overcoming an obstacle.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

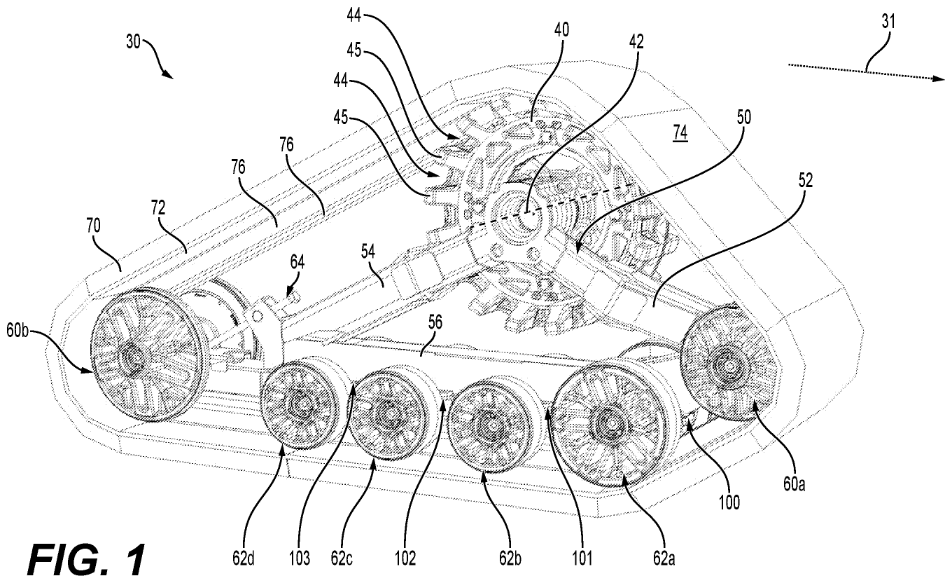

With reference to FIG. 1, the present technology will be described with reference to a track system 30, the forward direction of which is indicated by arrow 31. The track system 30 is operatively connectable to a vehicle (not shown). Specifically, the track system 30 is operatively connectable to a shaft of the vehicle. In the present description, the track system 30 is described as being operatively connected to a driving shaft. It is contemplated, however, that the shaft could not be a driving shaft. In some embodiments, the vehicle is a recreational vehicle such as a snowmobile, a side-by-side vehicle or utility-terrain vehicles. In other embodiments the vehicle is an agricultural vehicle such as a harvester, a combine or a tractor. In yet other embodiments, the vehicle is a construction vehicle such as a bulldozer, a skid-steer loader, an excavator or a compact track loader. It is further contemplated that the present technology could be used with industrial and military vehicles as well. It is also contemplated that the present technology could be used with trailers or other unpowered vehicles.

The track system 30 includes a sprocket wheel assembly 40 which can be operatively connected to a driving axle (not shown) of the vehicle. It is contemplated that in some embodiments, the sprocket wheel assembly 40 could be connected to a non-driving axle. The driving axle drives the sprocket wheel assembly 40 such that the sprocket wheel assembly 40 can rotate about a sprocket axis 42. The sprocket axis 42 is generally perpendicular to the forward direction of travel of the vehicle. The sprocket wheel assembly 40 defines laterally extending engaging members 44 (i.e., teeth) disposed on the circumference of the sprocket wheel assembly 40. The engaging members 44 are adapted, as will be described in greater detail below, to engage with lugs 76 provided on an inner surface 72 of the endless track 70. It is contemplated that in other embodiments, the configuration of the sprocket wheel assembly 40 could differ without departing from the scope of the present technology.

The track system 30 further includes a frame 50. The frame 50 includes a leading frame member 52, a trailing frame member 54 and a lower frame member 56. The leading and trailing frame members 52, 54 are jointly connected around the driving axle of the vehicle, the joint connection being positioned laterally outwardly from the sprocket wheel assembly 40. The leading frame member 52 extends from the driving axle, in the forward and downward directions, and connects to a forward portion of the lower frame member 56. The trailing frame member 54 extends from the driving axle, in the rearward and downward directions, and connects to a rearward portion of the lower frame member 56. The lower frame member 56, which is positioned below the joint connection, extends generally parallel to the forward direction of travel of the vehicle. In the present embodiment, the leading, trailing and lower frame members 52, 54, 56 are integral. It is contemplated that in other embodiments, the leading, trailing and lower frame members 52, 54, 56 could be distinct members connected to one another. It is further contemplated that in some embodiments, the frame 50 could include more or less than three members. In some embodiments, one or more of the leading, trailing and lower frame members 52, 54, 56 could be pivotally connected to one another.

With continued reference to FIG. 1, the track system 30 includes a leading idler wheel assembly 60a, a trailing idler wheel assembly 60b, and four support wheel assemblies 62a, 62b, 62c, 62d. Each of the leading and trailing idler wheel assemblies 60a, 60b and the support wheel assemblies 62a, 62b, 62c, 62d includes two laterally spaced wheels. It is contemplated that in some embodiments, one or more of the support wheel assemblies 62a, 62b, 62c, 62d could include one or two wheel tandems.

The leading idler wheel assembly 60a is rotationally connected to a leading end of the lower frame member 56.

The four support wheel assemblies 62a, 62b, 62c, 62d, which are disposed longitudinally rearwardly from the leading idler wheel assembly 60a, are connected to the lower frame member 56 by, respectively, pivoting assemblies 100, 101, 102, 103. The pivoting assemblies 100, 101, 102, 103 will be described in greater detail below. A diameter of the wheels of the support wheel assembly 62a is larger than a diameter of the wheels of the support wheel assemblies 62b, 62c, 62d. It is contemplated that in some embodiments, the wheels of the four support wheel assemblies 62a, 62b, 62c, 62d could all have the same diameter.

The trailing idler wheel assembly 60b is connected to the lower frame member 56 via a tensioner 64. The tensioner 64 is operable to adjust the tension in the endless track 70 by selectively moving the trailing idler wheel assembly 60b toward or away from the frame 50. It is contemplated that in some embodiments, the tensioner 64 could be connected to the leading idler wheel assembly 60a instead of the trailing idler wheel assembly 60b. In some embodiments, the tensioner 64 could be omitted.

The track system 30 also includes the endless track 70, which extends around components of the track system 50, notably the frame 50, the leading and trailing idler wheel assemblies 60a, 60b, the support wheel assemblies 62a, 62b, 62c, 62d and the pivoting assemblies 100, 101, 102, 103. The endless track 70 has the inner surface 72 and an outer surface 74. The inner surface 72 of endless track 70 has the left and right sets of lugs 76. The left and right set of lugs 76 are adapted to engage within the engaging members 44 of the sprocket wheel assembly 40. It is contemplated that in some embodiments, there could be only one set of lugs 76. The outer surface 74 of the endless track 70 has a tread (not shown) defined thereon. It is contemplated that the tread could vary from one embodiment to another. In some embodiments, the tread could depend on the type of vehicle on which the track system 30 is to be used and/or the type of ground surface on which the vehicle is destined to travel. In the present embodiment, the endless track 70 is an endless polymeric track. It is contemplated that in some embodiments, the endless track 70 could be constructed of a wide variety of materials and structures.

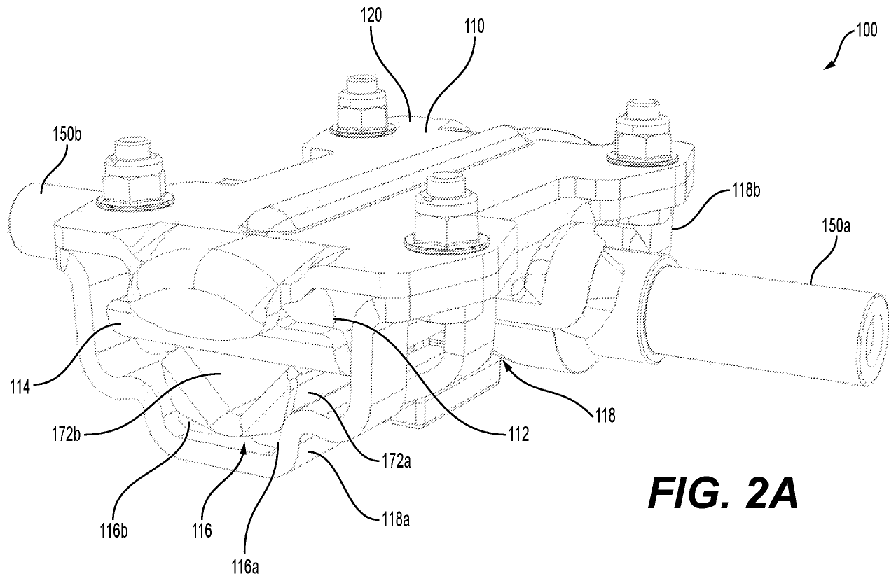

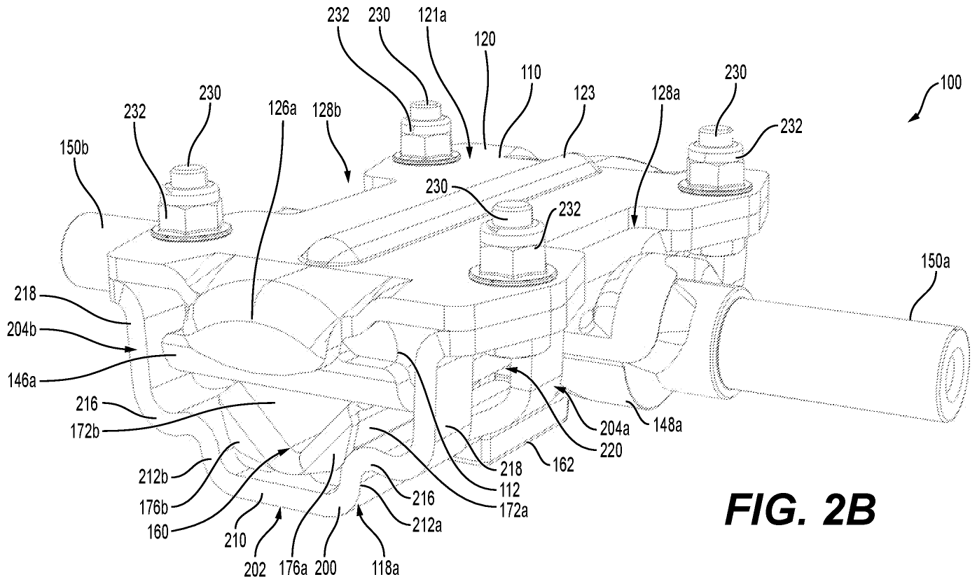

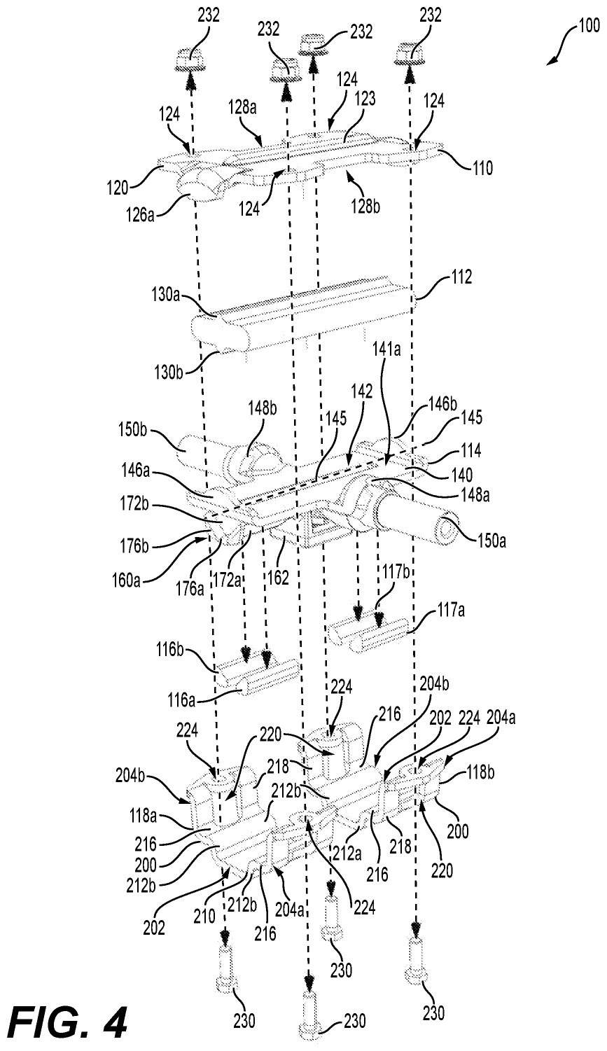

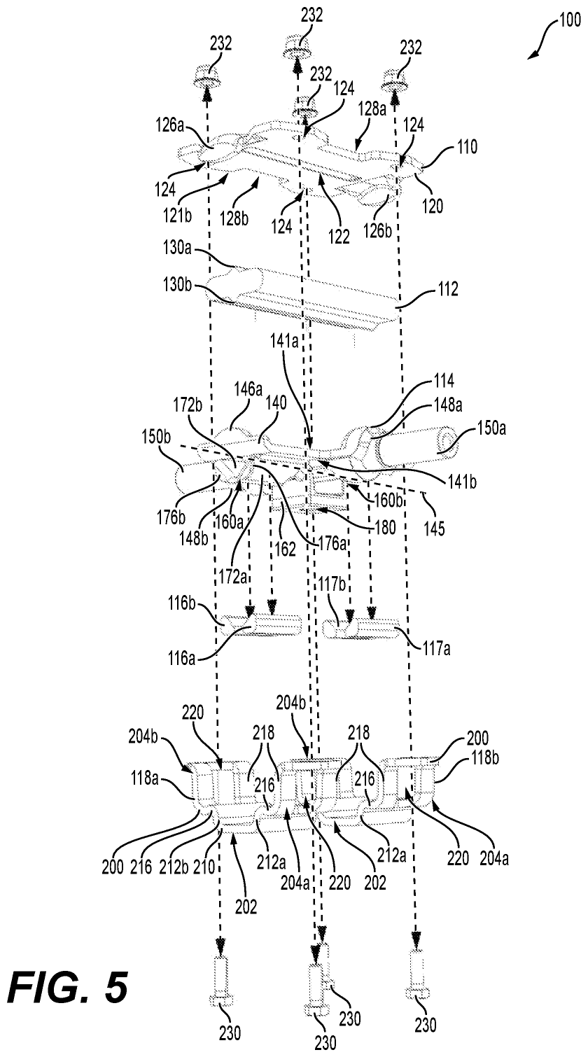

Referring now to FIGS. 2A, 2B and 3 to 5, the pivoting assemblies 100, 101, 102, 103 will be described in greater detail. Since the pivoting assemblies 100, 101, 102, 103 are generally similar, only the pivoting assembly 100 will be described in detail herewith.

The pivoting assembly 100 includes an upper clamping member 110, an upper resilient member 112, an intermediate clamping member 114, a lower resilient member 116, and a lower clamping member 118. Under clamping action of the upper clamping member 110 and of the lower clamping member 118, the upper resilient member 112 and the lower resilient member 116 enable a movement of the intermediate clamping member 114.

In some embodiments, the intermediate clamping member 114 houses a shaft 150. In some embodiments, the shaft 150 could be two different shafts 150a, 150b housed in the intermediate clamping member 114. Lower resilient member 116 comprises leading lower resilient members 116a, 116b, which are laterally spaced, and trailing lower resilient members 117a, 117b, which are also laterally spaced. Likewise, the lower clamping member 118 comprises a leading lower clamping member 118a and a trailing lower clamping member 118b.

As will be described in greater detail below, the upper resilient member 112 and the lower leading and trailing resilient members 116a, 116b, 117a, 117b enable a movement of the intermediate clamping member 114 such that that shaft 150 is moveable.

In the present embodiment, the upper clamping member 110 corresponds to a bottom part of the lower frame member 56, specifically a lower wall of the lower frame member 56. It is contemplated, however, that the upper clamping member 110 could be separate and distinct from the lower frame member 56. For example, the upper clamping member 110 could be fastened to the lower frame member 56.

With continued reference to FIGS. 2A, 2B and 3 to 5, the upper clamping member 110 has a generally elongate body 120 with a top side 121a and a bottom side 121b. Focusing on the bottom side 121b, the elongate body 120 has an inter-engageable feature 122. The inter-engageable feature 122 is a longitudinal recess 122 defined in the elongate body 120. As will be described below, the longitudinal recess 122 is configured to receive therein an inter-engageable feature 130a of the upper resilient member 112. As such, the longitudinal recess 122 is generally complementary to the inter-engageable feature 130a. In particular, the longitudinal recess 122 may be the result of a punching process so as to create a recess suitable for receiving the inter-engageable feature 130a which, in this embodiment, is a protrusion on the top surface of the upper resilient member 112. As a result of the punching process, there is a protrusion 123 on the top side 121a of the elongate body 120. It is contemplated that in some embodiments, the longitudinal recess 122 could be the result of an alternative process, such as a casting process. It is also contemplated that in some embodiments the longitudinal recess 122 could be machined such that the protrusion 123 could be omitted. In other embodiments, the longitudinal recess 122 could be machined without omitting the protrusion 123.

The elongate body 120 also defines connecting apertures 124 that are configured to receive bolts 230 therein. In this particular embodiment, the elongate body 120 defines four connecting apertures 124 at each one of the corners of elongate body 120. The elongate body 120 has a leading abutting portion 126a and a trailing abutting portion 126b, which are, as will be described below, for limiting longitudinal movement of the upper resilient member 112 relative to the upper clamping member 110. On lateral sides thereof, the elongate body 120 defines side recesses 128a, 128b. These side recesses 128a, 128b can increase pivotal range of motion of the shafts 150a, 150b about a longitudinal axis 145.

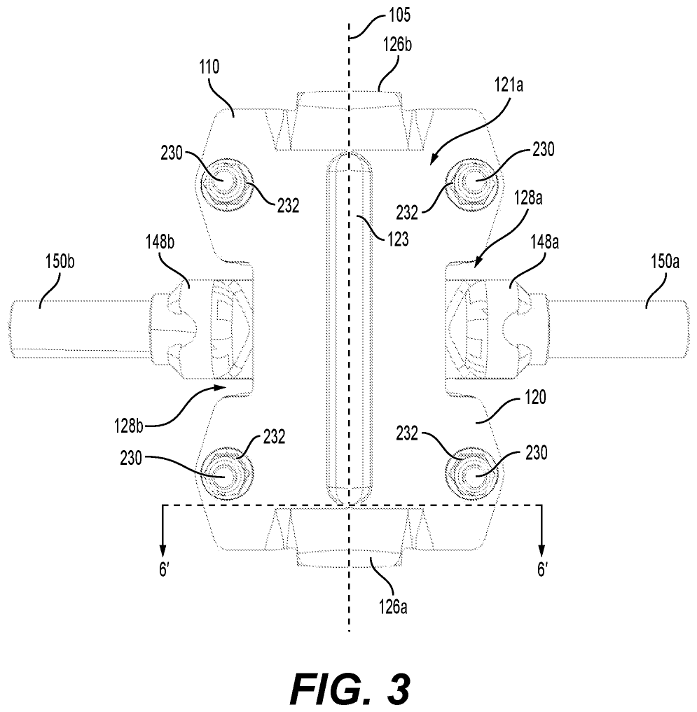

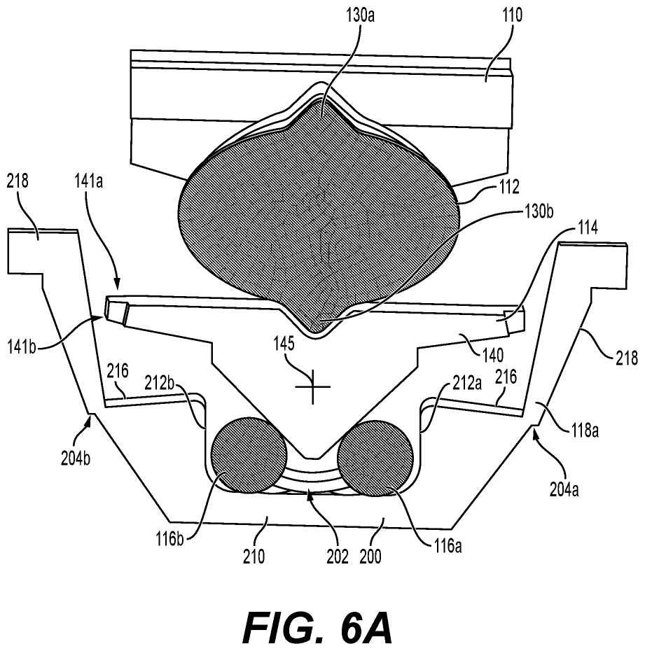

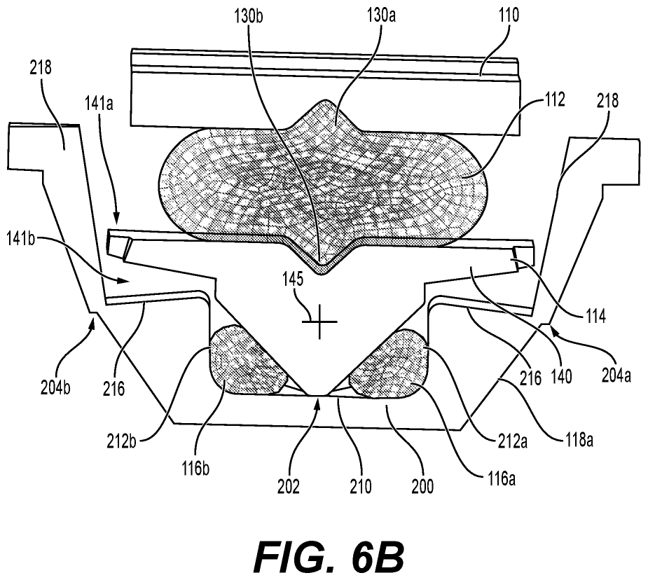

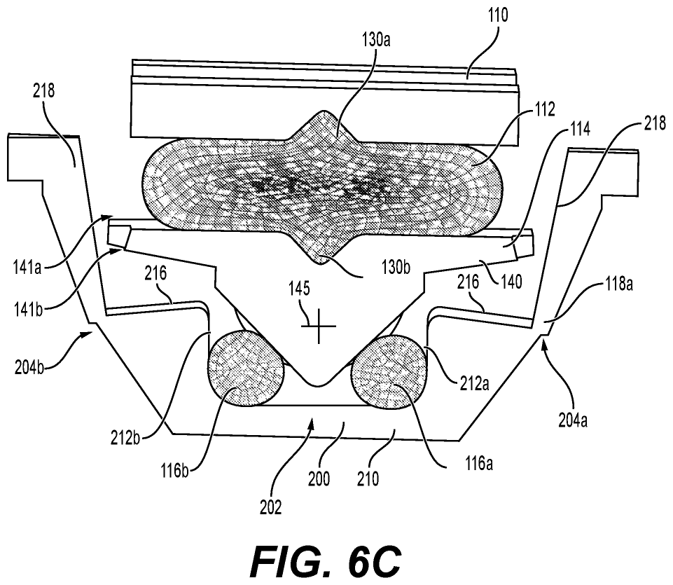

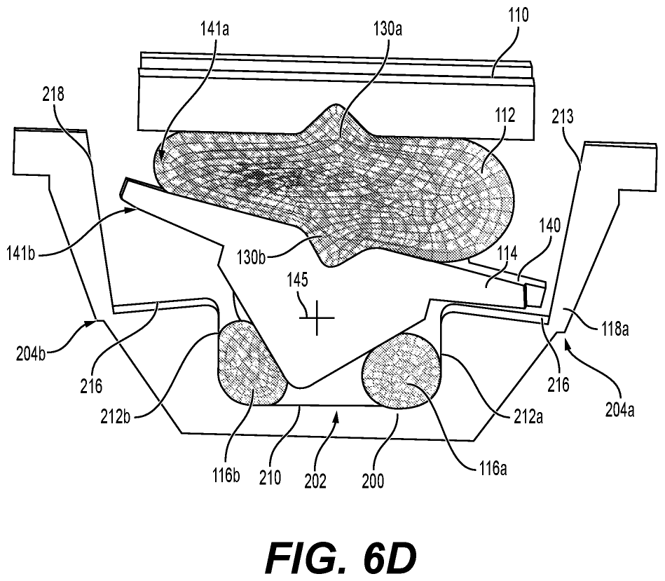

The upper resilient member 112, which is elongate, has the upper inter-inter-engageable feature 130a and a lower inter-engageable feature 130b. The upper and lower inter-engaging features 130a, 130b are, respectively, upper and lower protrusions 130a, 130b. FIG. 6A (greyed out) shows a configuration in which the upper resilient member 112 is not under load. A cross-sectional profile of the upper resilient member 112 taken across a plane that is perpendicular to a longitudinal center plane 105 (FIG. 3) of the pivoting assembly 100 shows that the upper resilient member 112 has a generally circular shape at rest. FIGS. 6B, 6C and 6D, show configurations in which the upper resilient member 112 is put under load (for instance, when the upper resilient member 112 is pre-loaded). A cross-sectional profile of the upper resilient member 112 taken across the plane perpendicular to the longitudinal center plane 105 shows that, when compressed, the upper resilient member 112 flattens towards a generally elongated shape (e.g., oval shape). In some instances, the cross-sectional profile of the upper resilient member 112 is uniform (i.e., the upper resilient member 112 is solid—not hollow) and can be manufactured by extrusion. It is understood that other manufacturing methods are contemplated. The upper resilient member 112 is made of a polymeric material. In the present embodiment, the polymeric material is rubber. It is contemplated that the upper resilient member 112 could be made of any other polymeric material that is able to resiliently and/or elastically deform under compressive and/or tensile forces. Furthermore, it is contemplated that that upper resilient member 112 could be two or more resilient members.

Still referring to FIGS. 2A, 2B and 3 to 5, the intermediate clamping member 114 will now be described in greater detail. The intermediate clamping member 114 has a generally elongate body 140 with an upper engaging side 141a that is generally flat, and a lower engaging side 141b. The elongate body 140 has an inter-engageable feature 142 which, in this embodiment, is a longitudinal recess 142 defined in the elongate body 140. As will be described below, the longitudinal recess 142 is configured to receive the protrusion 130b therein for providing a mechanical interlock therebetween. As such, the longitudinal recess 142 is complementary to the protrusion 130b. The elongate body 140 also has a leading abutting portion 146a and a trailing abutting portion 146b for limiting longitudinal movement of the upper resilient member 112 relative to the intermediate clamping member 110. The intermediate clamping member 110 has on either side thereof, side connectors 148a, 148b. The side connectors 148a, 148b extend in the lateral directions before extending vertically. The side connectors 148a, 148b are configured to receive and connect with, respectively, the shafts 150a, 150b. This connection between side connectors 148a, 148b and shafts 150a, 150b can assist in increasing pivotal range of motion of the shafts 150a, 150b about the longitudinal axis 145. It is contemplated that in some embodiments, the side connectors 148a, 148b could be configured to receive and connect with a single shaft. In other embodiments, the shafts 150a, 150b could be integral with the elongate body 140. The shafts 150a, 150b are configured to connect with a wheel or a tandem of the wheel assembly 62a. As will be described below, when the track system 30 encounters an obstacle which causes left and right wheels of the wheel assembly 62a to move in a vertical direction, the shafts 150a, 150b move accordingly. Since the shafts 150a, 150b are connected to the intermediate clamping member 114, the intermediate clamping member 114 also moves, in part due to the resilient nature of the upper resilient member 112 and the leading and trailing lower resilient members 116a, 116b, 117a, 117b.

The longitudinal axis 145 extends parallel to the longitudinal center plane 105, and through the intermediate clamping member 114. The longitudinal axis 145 is a virtual axis in that, longitudinal axis 145 moves or is displaced as the intermediate clamping member 114 moves or is displaced (i.e., due to the resilient nature of the upper resilient member 112 and the leading and trailing lower resilient members 116a, 116b, 117a, 117b).

Turning now to the lower engaging side 141b of the elongate body 140. The longitudinal recess 142 may be the result of a punching process, so as to create a protrusion (not shown in accompanying Figures) on the lower engaging side 141b. It is contemplated that in some embodiments, the longitudinal recess 142 could be the result of an alternative process, such as a casting process. Additionally, in some embodiments, the longitudinal recess 122 could be machined while omitting, or not, the protrusion. The lower engaging side 141b has a leading engaging member 160a and a trailing engaging member 160b. The lower engaging side 141b also has a middle member 162 that is disposed between the leading and trailing engaging members 160a, 160b. The leading and trailing engaging members 160a, 160b and the middle members 162 are fixedly connected to the elongate body 140. In some embodiments, the leading and trailing engaging members 160a, 160b and the middle member 162 are connected to the elongate body 140 by welding. It is contemplated that in other embodiments, the elongate body 140 and the leading and trailing engaging members 160a, 160b and the middle member 162 could be integral. In other embodiments, the leading and trailing engaging members 160a, 160b and the middle members 162 could be removably to one another and/or to the elongate body 140.

The leading and trailing engaging members 160a, 160b are similar, and hence only the leading engaging members 160a will be described in detail herewith.

The leading engaging member 160a has an engaging portion 172a configured to engage the leading lower resilient member 116a and an engaging portion 172b configured to engage the leading lower resilient member 116b. The engaging portions 172a, 172b are disposed at an angle from one another. Specifically, the engaging portions 172a, 172b are at about 40 degrees relative to one another, such that the leading engaging member 160a generally forms a V-shape. In some embodiments, an angle between the engaging portions 172a, 172b could be between about 10 and 120 degrees. As such when the leading engaging member 160a is connected to the elongate body 140, the elongate body 140 and the leading engaging member 160a form a downwardly oriented triangle. The engaging portion 172a has an abutting portion 176a, and the engaging portion 172b has an abutting portion 176b. As will be described below, the abutting portions 176a, 176b assist in limiting longitudinal movement of, respectively, the leading lower resilient members 116a, 116b relative to the elongate body 140.

The middle member 162 extends vertically past the leading and engaging members 160a, 160b. On a bottom surface thereof, the middle member 162 defines an aperture 180. It is contemplated that in some embodiments, the middle member 162 could be omitted, and leading and trailing engaging member 160a, 160b could be one engaging members. It is contemplated that in some embodiments, the middle member 162 could be omitted.

Still referring to FIGS. 2A, 2B and 3 to 5, the leading and trailing lower resilient members 116a, 116b, 117a, 117b will now be described in greater detail. The leading lower resilient members 116a, 116b engage the leading engaging member 160a, whereas the trailing lower resilient members 117a, 117b engage the trailing engaging member 160b. Although in this embodiment, leading and trailing lower resilient members 116a and 117a are distinct members, and leading and trailing lower resilient 116b, 117b are distinct members, it is contemplated that in some other embodiments, the leading and trailing lower resilient members 116a, 117a could be unitary or could be connected and the leading and trailing lower resilient members 116b, 117b could be unitary or could be connected such that there would be two lower resilient members (instead of four). It is also contemplated that in some further embodiments, the leading and trailing lower resilient members 116a, 116b, 117a, 117b could be connected, such that there would only be one lower resilient member.

As the leading and trailing lower resilient members 116a, 116b, 117a, 117b are similar, only the leading lower resilient member 116a will be described herewith.

The leading lower resilient member 116a is elongate. Specifically, the leading lower resilient member 116a is cylindrical, and extends generally parallel to the longitudinal center plane 105. FIG. 6A shows a configuration in which the leading lower resilient member 116a is not subjected to a pre-load. A cross-sectional profile of the leading lower resilient member 116a taken across the plane perpendicular to the longitudinal center plane 105 of the pivoting assembly is generally circular at rest. FIGS. 6C and 6D show configurations in which the leading lower resilient member 116a is under load (for instance, when the leading lower resilient member 116a is pre-loaded). In such configurations, a cross-sectional profile of the leading lower resilient member 116a taken across the plane perpendicular to the longitudinal center plane 105 shows that the leading lower resilient member 116a resiliently compresses so to adopt a more elongated shape (e.g., adopts triangular shapes) when compressed. Additionally, the cross-sectional profile of the leading lower resilient member 116a is uniform (i.e., leading lower resilient member 116a is solid—not hollow). As such, the leading lower resilient member 116a can be manufactured by extrusion. It is understood that other manufacturing methods are contemplated. The leading lower resilient member 116a is made of a polymeric material. In the present embodiment, the polymeric material is rubber. It is contemplated that the leading lower resilient member 116a could be made of any other polymeric material able to resiliently and/or elastically deform under the compressive and/or tensile forces. In some embodiments, mechanical properties of the lower resilient member 116a are the same as mechanical properties of the upper resilient member 112. In other embodiments, mechanical properties of the leading lower resilient member 116a could be different from the mechanical properties of the upper resilient member 112. For instance, the upper resilient member 112 could have a higher modulus or rigidity and/or elasticity than the leading lower resilient member 116a.

The leading and trailing lower clamping members 118a, 118b, which are removably connectable to the upper clamping member 110, will now be described in greater detail. The leading lower clamping member 118a is configured to receive part of the upper resilient member 112, part of the intermediate clamping member 114 and the leading lower resilient members 116a, 116b therein. Similarly, the trailing lower clamping member 118b is configured to receive part of the upper resilient member 112, part of the intermediate clamping member 114 and the trailing lower resilient members 117a, 117b therein. As the leading and trailing lower clamping members 118a, 118b are similar, only the leading lower clamping member 118a will be described in detail herewith.

The leading lower clamping member 118a has a body 200 that has a lower receiving portion 202 and side brackets 204a, 204b that extends upwardly from the receiving portion 202.

The receiving portion 202 includes a lower segment 210 and side segments 212a, 212b extending upwardly from both sides of the lower segment 210. In this particular embodiment, and as shown in FIGS. 6A to 6D, the edges between the lower segment 210 and side segments 212a, 212b are rounded (i.e., fillets are defined at the edges) for receiving the leading lower resilient members 116a, 116b.

The side segment 212a is connected to the side bracket 204a, and the side segment 212b is connected to the side bracket 204b. The side brackets 204a, 204b each have a lateral segment 216 and a vertical segment 218. The presence of the lateral segments 216 provides clearance for the intermediate clamping member 114 to pivot about longitudinal axis 145. The lateral segments 216 also serve as limiting segments, by limiting pivotal movement of the intermediate clamping member 114 via abutment. The vertical segments 218 each define an aperture 220. The apertures 220, while reducing material required to manufacture the leading lower clamping member 118a, also facilitate access to the bolts 230. The vertical segments 218 each also define a connecting aperture 224 configured to receive the bolts therethrough. The connecting apertures 224 are configured to be aligned with the connecting apertures 124.

The pivoting assembly 100 also includes bolts 230 and nuts 232 for connecting the upper clamping member 110 with the leading and trailing lower clamping member 118a, 118b. The bolts 230 are received through the connecting apertures 124 of the upper clamping member 110 and the connecting apertures 224 of the leading and trailing lower clamping members 118a, 118b. The nuts 232 are then fastened to the bolts 230. As will be described below, the connection between the bolts 230 and the nuts 232 induce a pre-load in the upper resilient member 112 and the leading and trailing lower resilient members 116a, 116b. In some embodiments, the connection between the bolts 230 and the nuts 232 can be adjusted to set the pre-load in the upper resilient member 112 and the leading and trailing lower resilient member 116a, 116b to a desired level. Although in this embodiment, four bolts 230 and four nuts 232 are depicted, it is contemplated that in other embodiments, there could be more or less than four bolts and four nuts. It is further contemplated that other fasteners could be used without departing from the present technology.

Referring to FIG. 6A, the pivoting assembly 100 in a disconnected configuration will now be described. In other words, the upper and lower clamping members 110, 118a, 118b are not connected to one another. In the disconnected configuration, the components of the pivoting assembly 100 are simply positioned relative to one another.

The upper resilient member 112 is disposed between the upper clamping member 110 and the intermediate clamping member 114. The leading lower resilient members 116a, 116b are disposed between the intermediate clamping member 114 and the leading lower clamping member 118a. Specifically, the leading lower resilient members 116a, 116b are disposed in the receiving portion 202 of the leading lower clamping member 118a. Similarly, the trailing lower resilient members 117a, 117b are disposed between the intermediate clamping member 114 and the trailing lower clamping member 118b. Specifically, the trailing lower resilient members 117a, 117b are disposed in the receiving portion 202 of the trailing lower clamping member 118b. In such disconnected configuration, the upper resilient member 112 and the leading and trailing lower resilient members 116a, 116b, 117a, 117b are not resiliently deformed, and are in unloaded/unstressed state.

Referring now to FIG. 6B, in the connected configuration, in which a preload is exerted on the pivoting system 100, the upper clamping member 110 and the leading and trailing lower clamping members 118a, 118b are connected to one another. In this embodiment, bolts 230 and nuts 232 connect the upper clamping member 110 to the leading and trailing lower clamping members 118a, 118b. The connection of the upper clamping member 110 and the leading and trailing lower clamping members 118a, 118b apply a clamping force to the upper resilient member 112 and the leading and trailing lower resilient members 116a, 116b, 117a, 117b, which induces a pre-load in the upper resilient member 112 and the leading and trailing lower resilient members 116a, 116b, 117a, 117b. In some embodiments, the connection between the upper clamping member 110 and the leading and trailing lower clamping members 118a, 118b could be adjustable, so as to vary the induced pre-load.

It is contemplated that in some embodiments, during connection, there could be adhesive applied between the upper clamping member 110 and the upper resilient member 112, between the upper resilient member 112 and the intermediate clamping member 114, between the intermediate clamping member 114 and the leading and trailing lower resilient members 116a, 116b, 117a, 117b, and/or between the leading and trailing lower resilient members 116a, 116b, 117a, 117b and the leading and trailing lower clamping members 118a, 118b.

In greater details, as a result of the connection of the upper and lower clamping members 110, 118a, 118b, an initial clamping force is applied to the upper resilient member 112 and the leading and trailing lower resilient members 116a, 116b, 117a, 117b. A first part of the initial clamping force, namely a first clamping force, is distributed by the upper clamping member 110 and the intermediate clamping member 114, which induce a first pre-load to the upper resilient member 112. A second part of the initial clamping force, namely a second clamping force, is distributed by the intermediate clamping member 114 and the leading and trailing lower clamping members 118a, 118b, which induce a second clamping force to the leading and trailing lower resilient members 116a, 116b, 117a, 117b. In some embodiments, the first and second clamping forces can be different. Thus, in response to the first and second clamping forces, the upper resilient member 112 and the leading and trailing lower resilient members 116a, 116b, 117a, 117b deform in compression. As a result, areas of contact between the upper resilient member 112 and the upper and intermediate clamping members 110, 114 increase. Areas of contact between the leading and trailing lower resilient members 116a, 116b, 117a, 117b and the intermediate and lower clamping members 114, 118a, 118b also increase. Increase in areas of contact as loads increase can help increase life of the resilient members 112, 116a, 116b, 117a, 117b as the loads are spread over a larger area.

It is to be noted that in the present embodiment, the upper clamping member 110 and the intermediate clamping member 114 are removably connected such that the upper resilient member 112 and the leading and trailing lower resilient members 116a, 116b, 117a, 117b are removable from the pivoting assembly. As such, the pivoting assembly 100 can be easily disassembled (e.g., by unfastening the bolts 230 and nuts 232). This is of interest particularly for maintenance purposes and for replacement of worn out components (e.g., the upper resilient member 112). This can be done with common tools.

In FIG. 6B, the pivoting assembly 100 is in the connected configuration and in a pre-loaded state. In this situation, the pivoting assembly 100 is not subjected to any external load. For instance, the pivoting assembly 100 is not subjected to any weight of the track system 30. In this configuration, the intermediate clamping member 114 and the longitudinal axis 145 are in pre-loaded positions.

Referring now to FIG. 6C, the pivoting assembly 100 is in the connected configuration and in a loaded state as the pivoting assembly 100 is subjected to external forces. For example, the pivoting assembly 100 can be subjected to a normal force resulting from a weight of the track system 30 (and part of a weight of the vehicle to which the track system 30 is connected).

In the loaded state, the wheels of the wheel assembly 62a engage a generally flat ground surface. As a result of the weight of the track system 30 (and part of the weight of the vehicle to which the track system 30 is connected), a normal force is applied to the wheels of the wheel assembly 62a causing the intermediate clamping member 214 to move vertically upward (i.e., toward the upper clamping member 110 and away from the leading and trailing lower clamping members 118a, 118b), to an upward position. In some instances, the vertical displacement of the intermediate clamping member 214 may be in the order of at least about 1 mm or at least about 2 mm. The vertical movement of the intermediate clamping member 214 can, in some instances, depend on the physical and/or mechanical properties (e.g., resilience and/or hardness properties) of the upper resilient member 112. As the intermediate clamping member 214 moves vertically upward the first clamping force is increased, whereas the second clamping force is reduced. As a result, the upper resilient member 112 further deforms in compression, whereas the leading and trailing lower resilient members 116a, 116b, 117a, 117b return towards their unstressed states. The upper resilient member 112, due to its resilient nature, is biased to return toward its unstressed state, and as such, is configured to bias in the intermediate clamping member and the longitudinal axis back toward their pre-loaded positions.

It is to be noted that in the present embodiment, the pivoting assembly 100 is configured such that once the intermediate clamping member 214 moves vertically, the leading lower resilient members 116a, 116b remain engaged with, respectively, the engaging portions 172a, 172b of the leading engaging member 160a, and the trailing lower resilient members 117a, 117b remain engaged with, respectively, the engaging portions 172a, 172b of the trailing engaging member 160b. In other words, the leading and trailing lower resilient members 116a, 116b, 117a, 117b are in continuous engagement with intermediate and lower clamping members 114, 118a, 118b. This can assist in preventing debris from lodging themselves between the leading and trailing lower resilient members 116a, 116b, 117a, 117b and the respective bodies 200 of the leading and trailing lower clamping members 118a, 118b. In turn, this can reduce wear of the leading and trailing lower resilient members 116a, 116b, 117a, 117b, and thus extend life thereof. Additionally, the leading and trailing lower resilient members 116a, 116b, 117a, 117b can reduce the amount of material required to manufacture a pivoting assembly when compared to, for example, a tubular bushing that would surround the intermediate clamping. As the leading and trailing lower resilient members 116a, 116b, 117a, 117b are positioned at strategic locations, smaller materials can be used.

Referring now to FIG. 6D, the pivoting assembly 100 as it overcomes an obstacle will now be described. As mentioned above, when the track system 30 encounters an obstacle, such as a rock or a ditch, the pivoting assembly 100 enables the wheel assembly 62a to move for conforming to the obstacle at least to some extent. This can, help load distribution within the endless track 70.

In the example shown in FIG. 6D, the intermediate clamping member 114 pivots about the longitudinal axis 145, such that, the shaft 150b (although not shown) moves in a vertically upward direction, whereas the shaft 150a (although not shown) moves in a vertically downward direction. It is contemplated that in some instances, the intermediate clamping member 114 pivots by at least about 5 degrees, or by at least about 10 degrees, or by at least about 15 degrees. In the present embodiment, the pivotal movement of the intermediate clamping member 114 is limited by the abutment between the intermediate clamping member 114 and the lateral segment 216 of the bracket 204a. In some instances, movement of the intermediate clamping member 114 could be limited by the abutment between the leading and trailing lower engaging members 160a, 160b and the lower segment 210.

As will be described below, the upper resilient member 112 and the leading and trailing lower resilient members 116a, 116b, 117a, 117b cooperate to guide movement of the intermediate clamping member 114.

As the intermediate clamping member 114 pivots about the longitudinal axis 145, the upper resilient member 112 deforms. In some instances, the deformation of the upper resilient member 112 is non-symmetrical. That is to say that one side of the upper resilient member 112 is further deforms in compression, whereas the other side of the upper resilient member 112 returns toward the unstressed state. The leading and trailing resilient members 116b, 117b are resiliently compressed, and the leading and trailing resilient members 116b, 117b move toward their unstressed states. The leading and trailing resilient members 116a, 117a are compressed laterally by the engaging portions 172b of the leading and trailing engaging members 160a, 160b.

As the upper resilient member 112 and the leading and trailing lower resilient members 116a, 116b, 117a, 117b are not fixedly connected to any one of the upper clamping member 110, the intermediate clamping member 114, and leading and trailing lower clamping members 116a, 116b for example via adhesive or by engaging members, the leading and trailing lower resilient members 116a, 116b, 117a, 117b can move (e.g., roll) relative to their respective engaging surfaces. The engagement between the protrusion 130a and the longitudinal recess 122 and between the protrusion 130b and the longitudinal recess 142 can assist in limiting how much the upper resilient member 112 move (e.g., rolls) relative to the upper and intermediate clamping members 110, 114. In some instances, since the pivoting assembly 100 is configured to have the upper resilient member 112 and the leading and trailing lower resilient members 116a, 116b, 117a, 117b move (e.g. roll), in part due to the resilient members 112, 116a, 116b, 117a, 117b being pre-loaded, the resilient members 112, 116a, 116b, 117a, 117b are less likely to slide relative to their engaging surfaces. A reduction in sliding can lead to a reduction in temperature, and thus can extend life of the resilient nature.

It is understood that due their resilient nature, the upper resilient member 112 and the leading and trailing resilient members 116b, 117b are biased to return toward their unstressed states. As such, the resilient member 112 and the leading and trailing resilient members 116b, 117b biases the pivoting assembly toward the connected configuration, unloaded state. This can assist the track system 30 in overcoming obstacles.

In some instances, during deformation, the upper resilient member 112 and the leading and trailing lower resilient members 116a, 116b, 117a, 117b can move longitudinally (for instance due to friction between one of the resilient member and the intermediate clamping member 214 if the intermediate clamping member 214 moves in longitudinal direction). In such instances, the longitudinal movements of the upper resilient member 112 and the leading and trailing lower resilient members 116a, 116b, 117a, 117b are limited. More precisely, the longitudinal movement of the upper resilient member 112 is limited by the abutting portion 126a, 126b, the longitudinal movements of the leading lower resilient members 116a, 116b are limited by the abutting portions 176a, 176b and the middle member 162 and the longitudinal movements of the trailing lower resilient members 117a, 117b are limited by the abutting portions 176a, 176b and the middle member 162. In some embodiments, the longitudinal movements of the upper resilient member 112 and the leading and trailing lower resilient members 116a, 116b, 117a, 117b could be further limited by the application of an adhesive between the upper resilient member 112 and the leading and trailing lower resilient members 116a, 116b, 117a, 117b and their respective engaging surfaces.

Modifications and improvements to the above-described embodiments of the present invention may become apparent to those skilled in the art. The foregoing description is intended to be exemplary rather than limiting. The scope of the present invention is therefore intended to be limited solely by the appended claims.

What is claimed is:

1. A pivoting assembly for connecting at least one-wheel assembly to a frame of a track system, the pivoting assembly comprising:
a first clamping member;
a first resilient member removably engageable with the first clamping member;
an intermediate clamping member having a first engaging side engageable with the first resilient member, and a second engaging side having a first engaging portion and a second engaging portion, the intermediate clamping member being pivotable about a pivot axis extending generally parallel to a longitudinal center plane of the pivoting assembly;
one second resilient member removably engageable with at least one of the first and the second engaging portions of the second engaging side of the intermediate clamping member;
a second clamping member removably connectable to the first clamping member and removably engageable with the second resilient member, the second clamping member having a receiving portion configured to at least partially receive the first resilient member, the intermediate clamping member and the second resilient member;
wherein the intermediate clamping member has a first position, and in response to the intermediate clamping member pivoting about the pivot axis, at least one of the first and second resilient members biases the intermediate clamping member towards the first position.

2. The pivoting assembly of claim 1, wherein in response to a connection between the first and second clamping members, an overall clamping force is applied, the first and intermediate clamping members distribute a first part of the overall clamping force to the first resilient member; and the intermediate and second clamping members distribute a second part of the overall clamping force to the second resilient member, and the pivoting assembly is in a pre-loaded state.

3. The pivoting assembly of claim 2, wherein the first resilient member is in continuous engagement with the first and intermediate clamping members, and the second resilient member is in continuous engagement with the intermediate and second clamping members.

4. The pivoting assembly of claim 1, wherein the second resilient member is two second resilient members removably engageable with the first and second engaging portions of the intermediate clamping member; and the first resilient member, and the two second resilient members cooperate for guiding movement of the intermediate clamping member.

5. The pivoting assembly of claim 1, wherein:
the intermediate member further includes a third engaging portion and a fourth engaging portion, and the second resilient member is four second resilient members;
the four second resilient members being removably engageable with the first engaging portion of the pivoting member; removably engageable with the second engaging portion of the pivoting member; removably engageable with the third engaging portion of the pivoting member; and removably engageable with the fourth engaging portion of the pivoting member.

6. The pivoting assembly of claim 1, wherein in response to a force being applied to the intermediate clamping member, the pivot axis and the intermediate clamping member move from the first position to a second position.

7. The pivoting assembly of claim 1, wherein in response to a force being applied to the intermediate clamping member, at least one of:
an area of contact between the first resilient member and the first clamping member increases,
an area of contact between the first resilient member and the first engaging side of the intermediate clamping member increases,
the first resilient member deforms;
an area of contact between the second resilient member and the second engaging side of the intermediate clamping member increases;
an area of contact between the second resilient member and the second clamping member increases, and
the second resilient member deforms.

8. The pivoting assembly of claim 1, wherein the first clamping member has a first inter-engageable feature, the first resilient member has a second inter-engageable feature and the first clamping member and the first resilient member are engageable by the first and second inter-engageable features.

9. The pivoting assembly of claim 1, wherein the first resilient member has a third inter-engageable feature, the intermediate clamping member has a fourth inter-engageable feature and the first resilient member and the intermediate clamping member are engageable by the third and fourth inter-engageable features.

10. The pivoting assembly of claim 1, wherein the first clamping member has a first abutting portion and a second abutting portion, the first and second abutting portions being configured to abut with the first resilient member for limiting longitudinal movement of the first resilient member relative to the first clamping member.

11. The pivoting assembly of claim 1, wherein at least one of:
the first resilient member is configured to move relative to one of the first and intermediate clamping members; and
the second resilient member is configured to move relative to one of the intermediate and second clamping members.

12. The pivoting assembly of claim 11, wherein at least one of:
the movement of the first resilient member relative to the one of the first and first and intermediate clamping members is a rolling movement; and
the movement of the second resilient member relative to the one of the intermediate and second clamping members is a rolling movement.

13. The pivoting assembly of claim 1, wherein the second clamping member is configured to limit movement of the intermediate clamping member.

14. The pivoting assembly of claim 1, wherein:
the first resilient member has a first mechanical property;
the second resilient member has a second mechanical property; and
the first and second mechanical properties are different from one another.

15. The pivoting assembly of claim 1, wherein a cross-section of at least one of the first resilient member and the second resilient member taken across a plane generally perpendicular to the longitudinal center plane of the pivoting assembly has a generally arcuate profile.

16. The pivoting assembly of claim 15, wherein the second resilient member is generally cylindrical, and extends generally parallel to the longitudinal center plane of the pivoting assembly.

17. The pivoting assembly of claim 1, wherein the intermediate clamping member includes at least one shaft extending generally perpendicular to the longitudinal center plane of the pivoting assembly, the at least one shaft being configured to connect to the at least one wheel assembly.

18. The pivoting assembly of claim 1, wherein the intermediate clamping member is configured to move in a vertical direction generally by at least about 1 millimetre.

19. The pivoting assembly of claim 1, wherein the intermediate clamping member can pivot about the pivot axis by at least about 5 degrees in either direction.

20. A track system comprising:
a frame;
a plurality of wheel assemblies operatively connected to the frame, at least one of the plurality of wheel assemblies being connected to the frame by the pivoting assembly of claims 1; and
an endless track surrounding the frame and the plurality of wheel assemblies.
